(19) United States
(12) Patent Application Publication
(10) Pub. No.: US 2009/0159465 A1
(43) Pub. Date: Jun. 25, 2009

(54) RELIEF VALVE

(75) Inventors: Peter John Mayer, Green Bay, WI (US); Michael Thomas Jagemann, Manitowoc, WI (US)

Correspondence Address: FOLEY & LARDNER LLP, 777 EAST WISCONSIN AVENUE, MILWAUKEE, WI, 53202-5306, US

(73) Assignee: Jagemann Stamping Company

(21) Appl. No.: 11/963,746

(22) Filed: Dec. 21, 2007

(51) Int. Cl. F16K 17/164; F16K 15/06; F16K 17/04; B65D 85/00; F17C 13/04

(52) U.S. Cl. 206/6; 137/542; 220/581; 29/428

(57) ABSTRACT

One embodiment relates to a valve including a tubular housing with first and second openings and an internal shoulder adjacent to the first opening. The valve further includes a pin having a first end and a second end opposite of the first end, a spring positioned about the pin, a seal located at the second end of the pin and adjacent the second end of the tubular housing, and a clip located at the first end of the pin. The clip engages with the internal shoulder of the tubular housing to compress the spring between the clip and the seal.

### BACKGROUND

The present invention relates generally to the field of relief valves. More specifically, the present invention relates to relief valves of the type which can be used with non-refillable gas cylinders. Relief valves for non-refillable gas cylinders present a number of material selection, structural configuration and manufacturing challenges for engineers and manufacturers. Attempting to address one challenge may give rise to other challenges, issues, and/or hurdles. For example, some relief valves have a hollow cylindrical housing or sleeve coupled to the body of the gas cylinder and a spring-loaded insert or core that is attached to the housing with a threaded connection. However, such a threaded connection requires very tight tolerances to ensure a close, reliable fit between the housing and core. The threaded connection may also have problems with cross-threading when installing the valve mechanism. Additionally, there may be dissimilar metal and manufacturing concerns which necessitate the increase or unnecessary use of relatively expensive materials such as brass.

It would be advantageous to provide a relief valve capable of being efficiently mass produced, reliable, easily secured to a gas cylinder, and mass produceable so that there is an acceptable range of variability from valve to valve.

### SUMMARY

One embodiment of the disclosure relates to a valve including a tubular housing with first and second openings and an internal shoulder adjacent to the first opening. The valve further includes a pin having a first end and a second end opposite of the first end, a spring positioned about the pin, a seal located at the second end of the pin and adjacent the second end of the tubular housing, and a clip located at the first end of the pin. The clip engages with the internal shoulder of the tubular housing to compress the spring between the clip and the seal.

Another embodiment of the disclosure relates to a gas canister. The gas canister includes a cylinder having a top portion. The top portion has a first opening and a second opening larger than the first opening. The gas canister further includes a main valve inserted in the second opening and a relief valve inserted in the first opening. The relief valve includes a tubular housing with first and second openings and an internal shoulder located adjacent the first opening of the tubular housing. The relief valve further includes a pin having a retainer adjacent a second end thereof, a spring positioned about the pin, a seal located at the second end of the pin and retained by the retainer. The relief valve further includes a clip located at a first end of the pin opposite of the second end. The clip engages with the internal shoulder of the tubular housing to compress the spring between the clip and the retainer to compress the seal into the second opening of the tubular housing.

Another embodiment of the disclosure relates to a method of manufacturing a gas canister. The method includes supplying a cylinder, attaching a main valve to the cylinder, and attaching a relief valve to the cylinder. The relief valve includes a tubular housing, a pin having a retainer adjacent a second end thereof, a spring positioned about the pin, a seal coupled at the second end of the pin and retained by the retainer, and a clip located at a first end of the pin opposite of the second end. The tubular housing includes first and second openings and an internal shoulder located adjacent to the first opening of the tubular housing. The clip engages with the shoulder to compress the spring between the clip and the retainer to compress the seal into the second opening of the tubular housing.

### BRIEF DESCRIPTION OF THE DRAWINGS

FIG. 1 is an isometric view of a gas canister including a relief valve according to an exemplary embodiment.

FIG. 2 is a cross section of the canister of FIG. 1 taken along line 2-2.

FIG. 3 is a cross section of the canister of FIG. 1 taken along line 3-3 showing the relief valve according to an exemplary embodiment.

FIG. 4 is an exploded view of the relief valve of FIG. 1 according to an exemplary embodiment.

FIG. 5 is a cross section of the relief valve of FIG. 1 showing the assembly of the relief valve according to an exemplary embodiment.

FIG. 6 is a flowchart of a method of manufacturing a gas canister including a relief valve according to an exemplary embodiment.

### DETAILED DESCRIPTION

Referring to FIG. 1, a container, shown as a gas canister or cylinder 10, includes a relief valve 14. Cylinder 10 is a thin-walled metal canister formed from a metal (e.g., carbon steel, stainless steel, aluminum, etc.) that is configured to hold a pressurized gas. Gas cylinders 10 are generally narrow cylindrical bodies with a mostly flat bottom and a rounded top. The rounded top generally has two openings: a first opening for a relief valve 14 and a second, larger opening for a main valve 12. Such gas cylinders 10 may be used in a variety of applications, such as camping, grilling, brazing or welding. According to an exemplary embodiment, cylinder 10 is formed from 1008 cold rolled steel with a deep drawing process. Cylinder 10 may be formed in multiple portions that are coupled together with welding, brazing, or another suitable process.

Gas cylinders 10 may contain a wide range of gasses including, but not limited to propane, propylene, oxygen, or a mixture of liquefied petroleum gas and methylacetylene-propadiene (e.g., MAPP® gas). The gas is normally released from cylinder 10 through a main valve 12 provided on the top of cylinder 10. Main valve 12 is inserted in an opening on gas cylinder 10. Main valve 12 receives a gas regulator (not shown) that allows a user to selectively release gas from gas cylinder 10. Gas regulators may then be connected to an appliance, such as a grill, lantern or hand held torch.

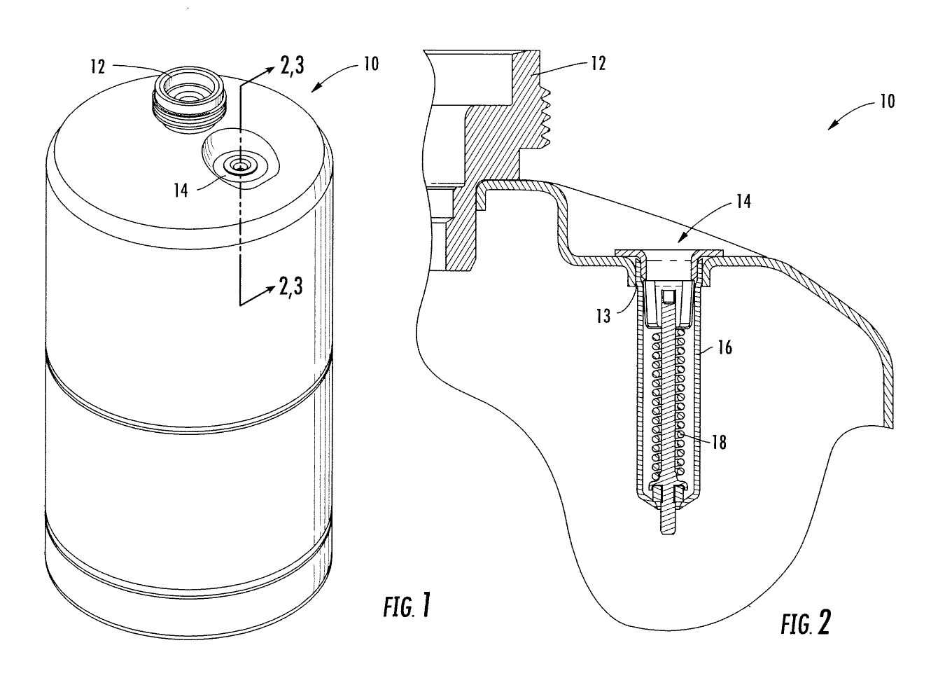

Relief valve 14 is inserted in an opening 13 in gas cylinder 10 and is provided to allow gas to escape the interior of cylinder 10 if the pressure inside cylinder 10 exceeds a predetermined level. Pressure inside cylinder 10 may increase, for example, if cylinder 10 is exposed to high temperatures that cause the gas inside cylinder 10 to expand. Additionally, in the case of a liquefied compressed gas, such as MAPP gas or propane, an increase in temperature may cause the liquid in cylinder 10 to change to a gas, thus increasing the pressure inside cylinder 10. Relief valve 14 helps to reduce the chance of cylinder 10 bursting. Referring to FIG. 2, relief valve 14 is inserted into hole 13 in the top of cylinder 10 and coupled to the cylinder 10 with a suitable process such as welding or brazing.

Referring now to FIGS. 3-5, a relief valve 14 is shown in more detail according to one exemplary embodiment. Relief valve 14 includes a housing shown as tubular housing 16, a pin 40 received by housing 16, a seal 50 coupled to pin 40, a spring 60 positioned about pin 40 that biases seal 50 against housing 16, and a clip 70 that retains pin 40, seal 50, and spring 60 within housing 16.

Housing 16 is a tubular member that is received by an opening in cylinder 10 and provides the main body of relief valve 14. Housing 16 may be a single unitary member, or may be constructed of multiple components. As shown in FIGS. 3-5, a first member or portion 20 of housing 16 includes a neck 22 and a flange 24 that extends outward from the upper edge of neck 22. First portion 20 defines a first opening 26 of housing 16. A second member or portion 30 of housing 16 includes a generally cylindrical side wall 32 and a lower end that extends inward to provide an internal seat 34 (e.g., ledge, shelf, end wall, etc.). A second opening 36 is adjacent seat 34. Second opening 36 is configured to receive an end of pin 40. Neck 22 of first portion 20 is configured to nest within side wall 32 of second portion 30. According to one exemplary embodiment, first portion 20 and second portion 30 are formed from a metal (e.g., carbon steel, stainless steel, aluminum, etc.). According to a preferred embodiment, first portion 20 and second portion 30 are formed from a cold rolled steel. According to a further preferred embodiment, first portion 20 and second portion 30 are formed from a metal coil with a deep drawing process using ASTM AS1008 DS Type B cold rolled steel. According to an alternative embodiment, first portion 20 may be formed from a copper-clad 1008 steel or any other suitable material. First portion 20 may be coupled to second portion 30 by welding (e.g. laser welding, friction welding, MIG welding, TIG welding, etc.), brazing, or another suitable coupling method. Housing 16 is pressed into an opening 13 in cylinder 10. Housing 16 may also be coupled to cylinder 10 by welding (e.g. laser welding, friction welding, MIG welding, TIG welding, etc.), brazing, or another suitable coupling method. Flange 24 extends outward beyond side wall 32 and is configured to rest on the outer surface of cylinder 10. Flange 24 is coupled to cylinder 10 with a suitable coupling method such as brazing or welding. In an alternate embodiment, flange 24 may be formed from a copper-clad 1008 steel, and coupled to cylinder 10 by heating up both flange 24 and cylinder 10 so that flange 24 is brazed to cylinder 10 as part of an assembly process.

As shown in FIGS. 3-5, housing 16 has an internal shoulder 28 located adjacent the first opening 26. Shoulder 28 may be formed from machining housing 16 (when housing 16 is a single unitary body) or may be formed when first portion 20 is inserted into second portion 30. As shown in the figures, first portion 20 has a smaller diameter neck 22 that fits into second portion 30, creating shoulder 28.

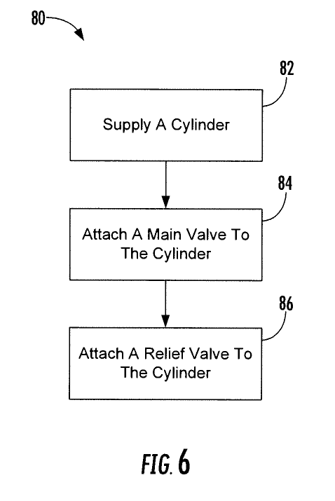

Pin 40 is an elongated member or rod that is received within housing 16. Pin 40 includes an upper or first end 46, a lower or second end 44, and an integrally formed flange or retainer 42 that extends outward from pin 40 adjacent to second end 44. Retainer 42 is configured to retain seal 50 on one side and spring 60 on the opposite side. Second end 44 is configured to receive seal 50. First end 46 may be configured to retain clip 70. As shown in FIGS. 3 and 5, first end 46 may be deformed or upset to create ridge 48. Ridge 48 may be configured to retain clip 70 to pin 40 during assembly of a valve core assembly 18. According to an exemplary embodiment, pin 40 is formed from UNS C26000 brass wire, another brass, or any other suitable material. According to one exemplary embodiment, retainer 42 is integrally formed with pin 40 in a cold heading process. According to other exemplary embodiments, retainer 42 and pin 40 may be formed separately and coupled (e.g., welded, brazed, etc.) together.

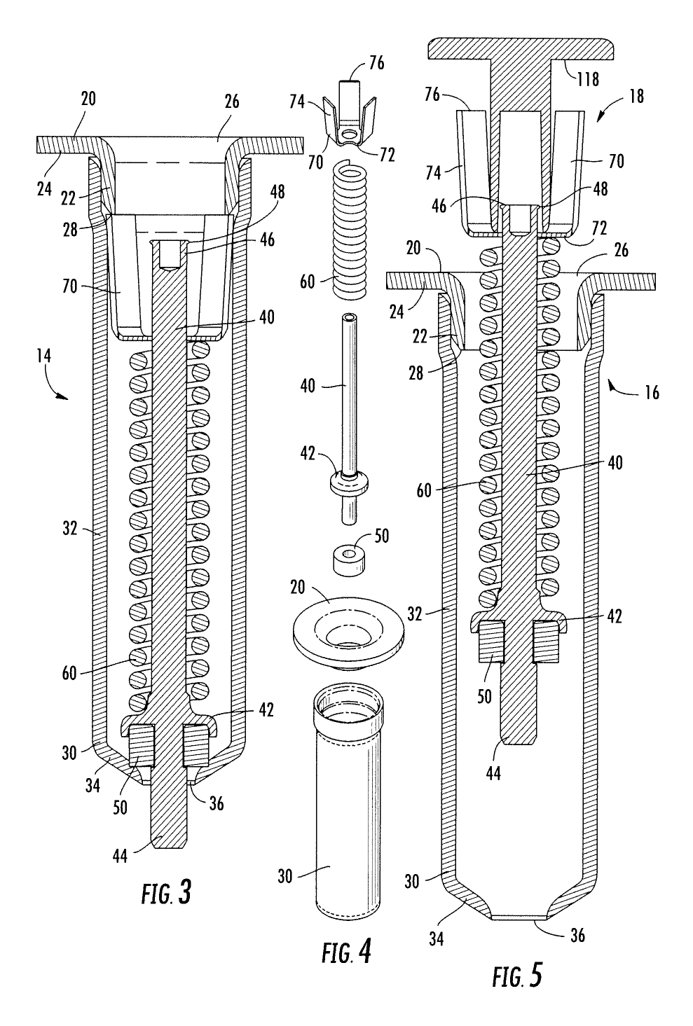

Seal 50 is a compressible member that is formed (e.g., molded, extruded and cut, die cut, etc.) from a resilient material (e.g., acrylonitrile-butadiene rubber (NBR)) or other suitable material. Seal 50 includes a central hole that allows seal 50 to be coupled to second end 44 of pin 40 proximate to retainer 52. As shown in FIGS. 3 and 4, the second end 44 of pin 40 shows a reduced diameter where it passes through the center of the seal 50. The reduced diameter may help in coupling seal 50 to pin 40. An alternative embodiment pin 40 has a constant diameter from second end 44 to the retainer 42. Seal 50 may be retained by friction alone to the constant diameter of second end 44 of pin 40. Retainer 42 stops seal 50 from being forced along pin 40 towards first end 46.

Spring 60 is a coil spring and may be formed from any suitable material (e.g., 302 stainless steel). Spring 60 is configured to bias seal 50 towards housing 16. Spring 60 is positioned around pin 40 and is trapped or retained between retainer 42 and clip 70.

Clip 70 is formed from a resilient material such as spring steel and is configured to retain pin 40, seal 50, and spring 60 inside housing 16. According to an exemplary embodiment, clip 70 is a stamped member formed from half-hard tempered 302 stainless steel. Clip 70 includes a central portion 72 with an opening that is configured to receive first end 46 of pin 40. Clip 70 further includes multiple arms 74 that extend outward from central portion 72. In a free state or position, edges 76 of arms 74 form a perimeter that is larger than the diameter of second portion 30 of housing 16.

Clip 70 may be constructed in different shapes and sizes. For instance, different shapes and sizes of clip 70 may be used in relief valves for cylinders configured to hold gasses under different pressures. In one embodiment, clip 70 may have longer arms 74 to obtain a higher gas retention pressure. In another embodiment, clip 70 may have shorter arms 74 to obtain a lower gas retention pressure. Additionally, clip 70 may be made of a thicker or thinner material to compress the spring a specific amount in order to develop the required gas retention pressure. In an alternative embodiment, spring 60 may be formed in various sizes and with various spring coefficients to achieve various gas retention pressures.

As shown in FIG. 5, pin 40, seal 50, spring 60, and clip 70 are assembled into a valve core assembly 18. Second end 44 of pin 40 may be configured to retain seal 50 or seal 50 may be configured to be coupled to pin 40. First end 46 of pin 40 may be deformed or upset to retain clip 70 on pin 40. As valve core assembly 18 is inserted into housing 16, arms 74 of clip 70 are compressed inward by neck 22. When valve core assembly 18 is fully inserted into housing 16, arms 74 clear neck 22 and are allowed to bias outward. Spring 60 biases clip 70 away from seal 50 and against an inner shelf or shoulder 28 formed adjacent the end of neck 22. With seal 50 biased against seat 34 and edges 76 of clip 70 biased against shoulder 28, valve core assembly 18 is trapped or retained in housing 16. As shown in FIGS. 3 and 5, shoulder 28 is located on first portion 20 of housing 16. In an alternative embodiment, shoulder 28 may be located on second portion 30 of housing 16. In another alternative embodiment, shoulder 28 maybe located on housing 16 when housing 16 is a single unitary body. Shoulder 28 provides a square or flat seat for positive retention of clip 70. Positive retention of clip 70 locks clip 70 into housing 16, thus positively retaining or locking valve core assembly 18 into housing 16.

If the pressure of the gas in cylinder 10 reaches a predetermined threshold, relief valve 14 is activated. According to an exemplary embodiment, relief valve 14 is configured to retain (i.e. not release) a gas such as propane or MAPP® gas in cylinder 10 at 130 degrees Fahrenheit. Gas pressure from inside cylinder 10 presses outward against seal 50 and compresses spring 60. When seal 50 moves away from seat 34, a passage is created to allow gas to pass through second opening 36, through relief valve 14 and out first opening 26 to the atmosphere. When the gas pressure inside cylinder 10 pressing outward on seal 50 is less than the opposing spring pressure on seal 50 by spring 60, seal 50 is biased towards seat 34, closing second opening 36. The pressure at which relief valve 14 begins to allow gas to escape cylinder 10 is the set or “start-to-discharge” pressure. According to an exemplary embodiment, relief valve 14 has a set pressure of at least 300.3 psi for propane and at least 246.8 psi for MAPP® gas. Relief valve 14 is configured to allow at least 18.18 cubic feet per minute free air to pass through at a pressure of 457.6 psi. For the purpose of this disclosure, “free air” is the flow rate adjusted to 16.696 psia and 60 degrees Fahrenheit.

Referring to FIG. 6, a method of manufacturing a gas canister 80 is shown according to an exemplary embodiment. A first step 82 includes supplying a cylinder 10. According to an exemplary embodiment, cylinder 10 is formed from 1008 cold rolled steel with a deep drawing process. Cylinder 10 may be formed in multiple portions that are coupled together with welding, brazing, or another suitable process. Cylinder 10 includes a first opening for a relief valve 14 and a second, larger opening for a main valve 12.

A next step 84 includes attaching main valve 12 to cylinder 10. A next step 86 includes attaching relief valve 14 to cylinder 10. According to an exemplary embodiment, housing 16 of relief valve 14 is pressed into opening 13 in cylinder 10 and is coupled to cylinder 10 with a suitable coupling method such as brazing or welding. Valve core assembly 18 is inserted into housing 16 until retainer clip 70 engages shoulder 28. A valve core assembly tool 118 may be used to insert valve core assembly 18 into housing 16. The valve core assembly tool 118 may surround the first end 46 of pin 40 and press on clip 70 to insert valve core assembly 18 into housing 16. When surrounding the first end 46, the valve core assembly tool may be inserted into or around the first end 46 of pin 40. Additionally, the valve core assembly tool may hold, retain, or guide pin 40 when pressing or pushing on clip 70. The valve core assembly tool 118 may be constructed of hardened tool steel or other suitable materials. The valve core assembly tool 118 may be retrofitted on current relief valve assembly machines and may rotate or not rotate when operated.

For purposes of this disclosure, the term “coupled” means the joining of two components directly or indirectly to one another. Such joining may be stationary in nature or movable in nature. Such joining may be achieved with two members and any additional intermediate members being integrally formed as a single unitary body with one another or with the two members or the two members and any additional member being attached to one another. Such joining may be permanent in nature or alternatively may be removable or releasable in nature.

The construction and arrangement of the elements of the relief valve shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements, the position of elements may be reversed or otherwise varied, and the nature or number of discrete elements or positions may be altered or varied. It should be noted that the elements and/or assemblies of the system may be constructed from any of a wide variety of materials that provide sufficient strength or durability, including any of a wide variety of moldable plastic materials in any of a wide variety of colors, textures and combinations. Other substitutions, modifications, changes and omissions may be made in the design, operating conditions and arrangement of the exemplary embodiments.

What is claimed is:

1. A valve, comprising:
a tubular housing including first and second openings and an internal shoulder located adjacent the first opening;
a pin having a first end and a second end opposite of the first end;
a spring positioned about the pin;
a seal located at the second end of the pin and adjacent the second opening of the tubular housing; and
a clip located at the first end of the pin, the clip engaging the internal shoulder of the tubular housing to compress the spring between the clip and the seal.

2. The valve of claim 1 further comprising a retainer adjacent the second end of the pin.

3. The valve of claim 2 wherein the retainer comprises a first side and a second side, the first side configured to retain the spring and the second side configured to retain the seal.

4. The valve of claim 2 wherein the pin and the retainer are two separate pieces.

5. The valve of claim 1 wherein the tubular housing comprises a first member and a second member.

6. The tubular housing of claim 5 wherein the second member is welded or brazed to the first member.

7. The tubular housing of claim 5 wherein the first member is constructed from a copper clad material and wherein the second member is brazed to the first member by heating the tubular housing.

8. The valve of claim 1 wherein the pin has an upset head at the first end thereof, the upset head configured to retain the clip.

9. The valve of claim 1 wherein the clip has at least one arm.

10. A gas canister, comprising:
a cylinder having a top portion, the top portion having a first opening and a second opening larger than the first opening;
a main valve inserted in the second opening; and
a relief valve inserted in the first opening, the relief valve comprising:
a tubular housing including first and second openings and an internal shoulder located adjacent the first opening of the tubular housing;
a pin including a retainer adjacent a second end thereof;
a spring positioned about the pin;
a seal located at the second end of the pin and retained by the retainer; and
a clip located at a first end of the pin opposite of the second end, the clip engaging the internal shoulder of the tubular housing to compress the spring between the clip and the retainer to compress the seal into the second opening of the tubular housing.

11. The gas canister of claim 10 wherein the tubular housing is welded or brazed to the cylinder.

12. The gas canister of claim 10 wherein the tubular housing comprises a first portion and a second portion.

13. The gas canister of claim 10 further comprising a gas regulator coupled to the main valve and an appliance coupled to the gas regulator.

14. The gas canister of claim 13 wherein the appliance is a hand-held torch, a grill, or a lantern.

15. A method of manufacturing a gas canister, comprising the steps:
supplying a cylinder;
attaching a main valve to the cylinder;
attaching a relief valve to the cylinder;
the relief valve comprising:
a tubular housing including first and second openings and an internal shoulder located adjacent the first opening of the tubular housing;
a pin including a retainer adjacent a second end thereof;
a spring positioned about the pin;
a seal coupled at the second end of the pin and retained by the retainer; and
a clip located at a first end of the pin opposite of the second end, the clip engaging the shoulder to compress the spring between the clip and the retainer to compress the seal into the second opening of the tubular housing.

16. The method of claim 15 wherein the relief valve is inserted and brazed into a hole in the cylinder.

17. The method of claim 15 wherein the relief valve is inserted and welded into a hole in the cylinder.

18. The method of claim 15 wherein the pin, seal, spring and clip are inserted into the tubular housing after the tubular housing is inserted into the cylinder.

19. The method of claim 18 wherein the pin, seal, spring and clip are inserted into the tubular housing by a relief valve assembly tool.

20. The method of claim 15 wherein the relief valve assembly tool surrounds the second end of the pin and presses on the clip to insert the pin, seal, spring and clip into the tubular housing.
